(19) United States
(12) Patent Application Publication
(10) Pub. No.: US 2005/0165674 A1
(43) Pub. Date: Jul. 28, 2005

(54) Transaction authentication

(76) Inventors: Nicholas Hector Edwards, Ipswich (GB); James CT Chapman, Ipswich (GB); Maurice M. Gifford, Kesgrave (FR)

Correspondence Address: NIXON & VANDERHYE, PC, 901 NORTH GLEBE ROAD, 11TH FLOOR, ARLINGTON, VA, 22203, US

(21) Appl. No.: 10/507,824

(22) PCT Filed: Mar. 18, 2003
(86) PCT No.: PCT/GB03/01137

(30) Foreign Application Priority Data
Mar. 22, 2002 (EP) 02252105.8

(51) Int. Cl. G06F 17/60; G06F 7/00; G06F 17/00

(52) U.S. Cl. 705/39; 709/213; 707/100

(57) ABSTRACT

In a transaction authorisation arrangement a sales point (1) (an electronic point of sale device or a vending machine, for example) communicates with a transaction application (2) transmitting thereto a transaction value. The telephony platform (3) reserves one of a series of premium rate numbers (5) which can be dialled up by a mobile telephone user to authorise the charging of the transaction against the telephone bill. When a call is received at the premium rate number the telephony platform notifies the transaction application which then authorises the sale.

The present invention relates to transaction authentication and more particularly to authentication and verification of point of sale (pos) electronic transactions.

For low value transactions at a retail point of sale use of credit or debit cards can result in significant overhead for the retailer due to transaction charges by banking services. There is also a significant time delay for customers as the transaction usually requires that a slip is printed with the details of the transaction, the slip requiring to be signed by the customer before the retailer can serve another customer.

Some attempts to overcome the above mentioned difficulties have been made for example by the use of non-customer specific transaction cards which carry a memory of the amount of money credited thereto. These cards allow the retailer to carry out a transaction automatically by inserting the card in a read/write terminal which checks the available cash balance, deducts the amount of the transaction and writes back a new cash balance. Such cards are vulnerable to theft or loss and also require the user to visit a terminal in order to add further money to the card.

In co-pending PCT Patent Application No GB01/04836 (also assigned to the assignee of the present application) there is disclosed a payment validation system in which a users mobile (cellular) telephone is used to confirm a transaction made through a vending node either by requiring the customer to dial a displayed telephone number or by causing a call to be established to the customer to confirm the transaction which is then charged to a specified customer account and authorisation provided to the vending node.

It is known to vend goods and services by allowing a premium rate number to be called. This may require a long call to be made in order to raise the value of an item to be purchased. This also requires the vendor to own a premium rate number or numbers permanently allocated to the individual vendor.

In published PCT application no WO 00/77697 there is disclosed a method for controlling vending machine sales in which each vending machine has a specific number, possibly a “freefone” number, which may be called by a cellular phone user to purchase goods and services. The machine includes a telephony interface which receives the call and identifies the calling cellular phone from the calling line identity. Transactions are recorded at the machine and subsequently transferred to the telephone service provider to effect billing of the consumer.

According to the present invention there is provided a transaction authorisation system comprising a service platform in communication with a telephone network, and a plurality of sales points each point having respective customer communication means responsive to signals from the service platform to communicate to a customer or a customer terminal associated with the customer information defining a node of the communications network to which calls can be placed, the service platform including means responsive to a request from sales point to select one of a multiplicity of network nodes for transfer and to communicate the identity of the selected network node to the requesting terminal and monitoring means for monitoring the selected network node for a communication, means for capturing the identity of a customer terminal calling the selected network node and means to indicate to the requesting point of sales terminal that a transaction is authorised.

In one embodiment of the invention there are a plurality of sets of telephone numbers each set being associated with a respective transaction value whereby calls to a selected number cause charging of a corresponding value to a customer account associated with the calling customer terminal.

The calling customer terminal may be a mobile or cellular phone to which the sales terminal directly transmits the received telephone number. Alternatively the sales terminal may include display means which displays the telephone number to be called for entry to the customer terminal by the customer.

According to another aspect of the present invention there is provided a method of charging for a transaction comprising the steps of identifying a value for the transaction, selecting from a plurality of telephone numbers a number having a corresponding value associated therewith, displaying the number selected and monitoring a network node corresponding to the number selected for an incoming call, on receipt of an incoming call determining the identity of the calling terminal, charging an amount corresponding to the value to a respective account associated with the calling terminal and authorising the transaction.

Preferably the account is a pre-paid account and the method includes determining the sufficiency of credit in the respective account prior to authorising the transaction. Alternatively, the account may be a post pay account which may have an associated credit limit and the method includes the step of determining the sufficiency of available credit prior to authorising the transaction.

A feature of the invention provides a method of charging for a transaction comprising the steps of identifying a value for the transaction selecting a network node from a plurality of available network nodes, transmitting the identity of the node for transmission to a user, monitoring the selected network node for a call and identifying the calling terminal and debiting an account associated with the calling terminal prior to authorising the transaction.

A transaction authentication system in accordance with the invention will now be described by way of example only with reference to the accompanying drawings of which:

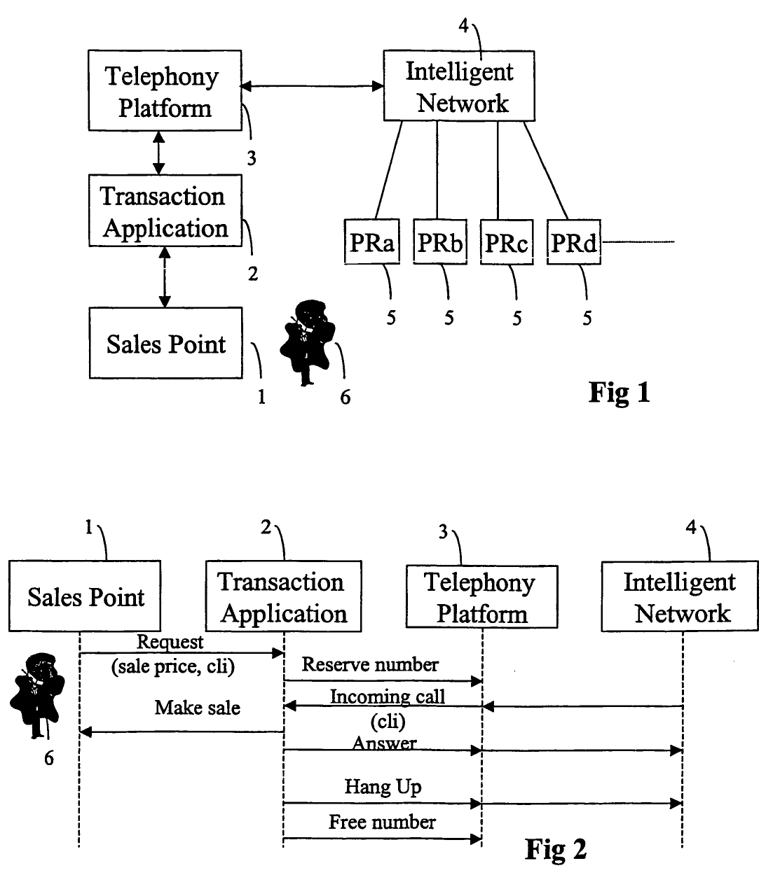

FIG. 1 is a block schematic diagram of a first system in accordance with the invention;

FIG. 2 is a message flow diagram showing the system of FIG. 1 in operation in a successful transaction;

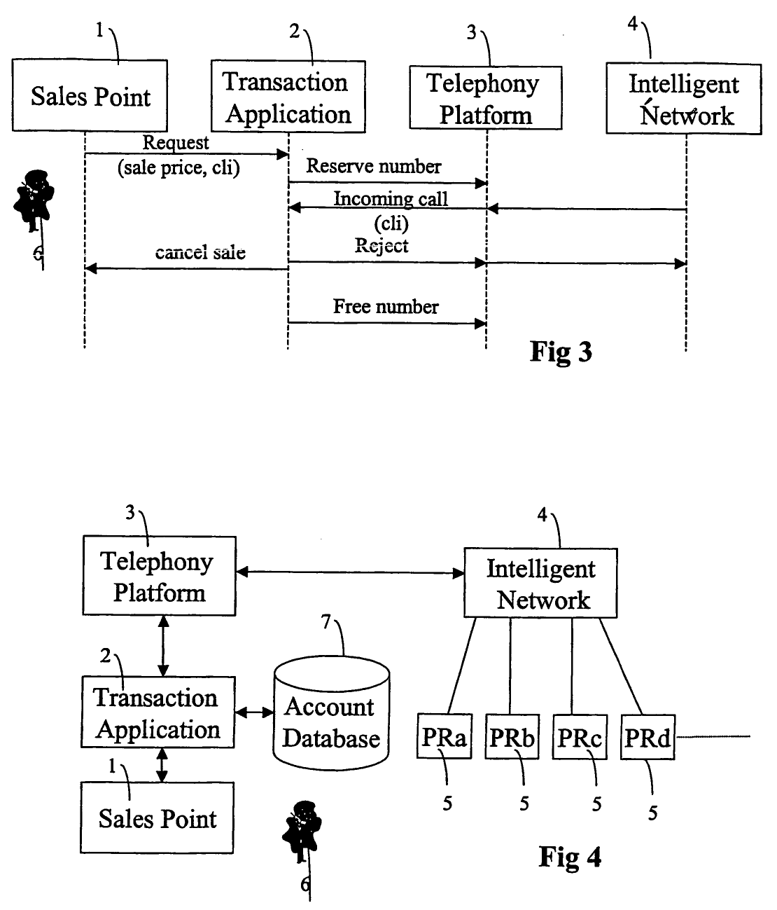

FIG. 3 is a message flow diagram showing the system of FIG. 1 in operation in an unsuccessful transaction

FIG. 4 is a block schematic diagram which shows a further development of the system for an alternative method of operation;

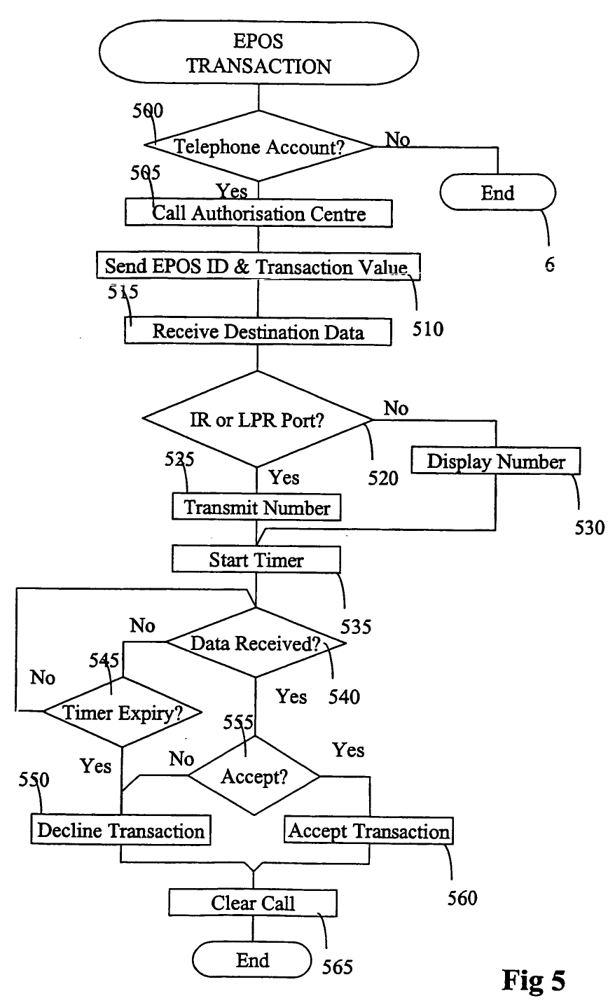

FIG. 5 is a flowchart of an adaptation of an EPOS terminal program;

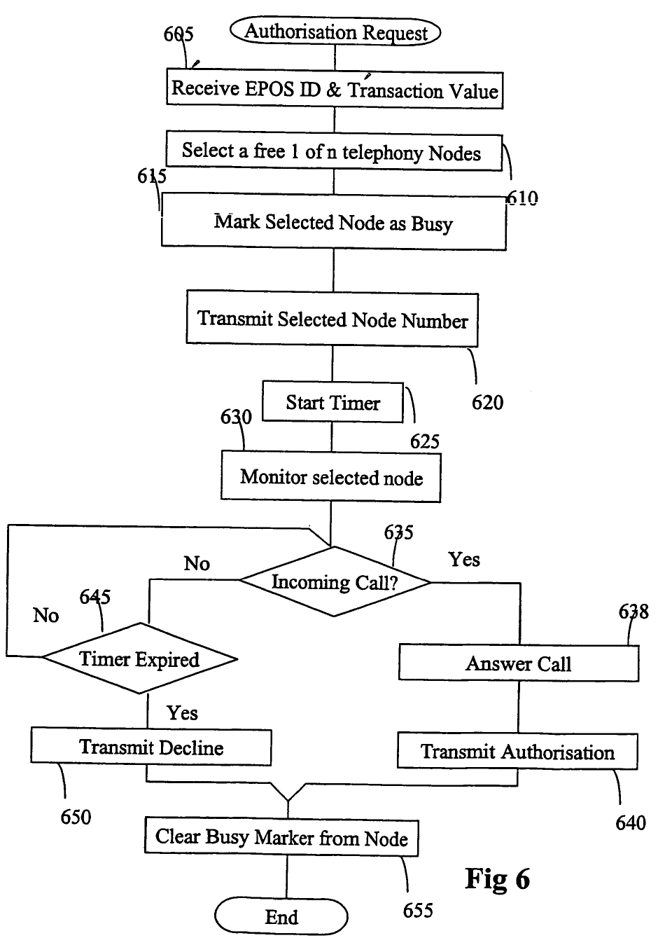

FIG. 6 is a flowchart of an instance of a transaction application; and

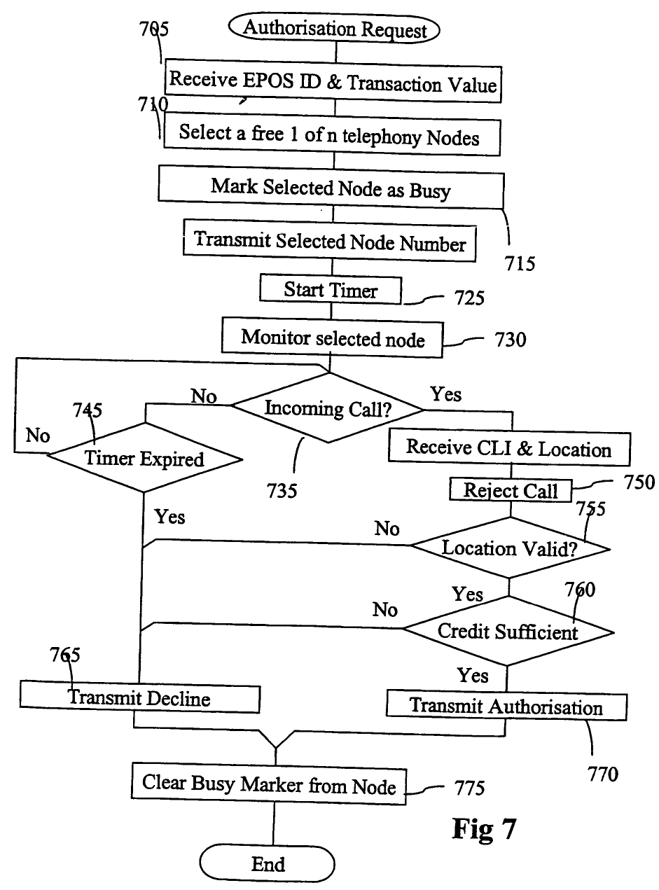

FIG. 7 is a flowchart of an alternative mode of operation of a transaction application.

Referring first to FIG. 1 a part of the invention resides in a modified electronic sales terminal indicated as sales point 1. The sales point 1 may be a shop till or incorporated in a vending machine or could be simply a node on the Internet.

The sales point 1 is in communication with a transaction application 2 for example either in a dial-up or ADSL communication mode, the transaction application residing in a computing platform or as a computing platform within a telephone network (not shown). The transaction application 2 communicates with the telephony platform 3 within the system, which communicates in turn with an intelligent network 4.

Within the intelligent network 4 a number of premium rate single charged telephone numbers are allocated in groups to each of a plurality of charges, for example, PRa may represent a charge of 25 p, PRb a charge of 50 p, PRc a charge of 75 p and PRd a charge of £1.00. The figures quoted are purely exemplary and it will be appreciated that a series of premium rate numbers may be provided each having any allocated value.

In an alternative method of operation, the premium rate numbers selected may be informed of a charge to be applied to a telephone bill in respect of that premium rate number and the immediately occurring transaction.

Referring briefly to FIG. 2, when a sales point 1 completes a transaction with a customer it forwards a request to the transaction application 2 being a request message incorporating the identity of the sales point 1 and the total sale price. The transaction application will now reserve one of the numbers in an appropriate group 5 reflecting the sale price and will return data to the sales point 1 identifying the reserved number. The telephony platform 3 now awaits an incoming call by way of the intelligent network 4 and when the call is received authorises the sale and effects answer of the call through the telephone platform 3 thereby causing the intelligent network 4 to make the appropriate fixed premium rate charge to the customer calling line. Once the sale has been made, the transaction application 2 will hang up the telephone call at the telephony platform 3 thereby clearing the number for further use by another consumer.

Referring to FIG. 3, if a request results in an incoming call to a premium rate number which has insufficient funding associated with the calling line identity (CLI) of the consumer then the application will be rejected and the call cleared, and a message is returned to the sales point 1 declining the sale through the selected route. The number is again freed in the final stage.

FIG. 4 shows an alternative implementation in which an account database is specifically associated with a CLI. In this case an account database 7 is maintained in communication with the transaction application software 2. The premium rate number ranges 5 may each be allocated to a higher value transaction, for example, £5.00, £10.00, £15.00 or £20.00, so that when a call is made to the particular premium rate number the amount charged to the subscriber is credited to a separate account held in the account database 7. Now when a transaction is requested from the sales point 1 a call is made to a non-premium rate number of the network so that the telephony platform 3 and transaction application 2 can capture the CLI and thereby apply appropriate charging raised by the sales point 1 to the account database.

In an alternative mode of operation, the sales point 1 may be able to communicate with consumer telephone 6 to capture the CLI through infrared or low power radio communication and this may result in a call outgoing from the telephony platform 3 to the telephone instrument 6 associated with the transaction. In this case the sale price and CLI are transmitted to the transaction application 2 from the sales point 1 and the telephony platform 3 simply makes a call through the intelligent network 4 and the cellular network (if appropriate) to confirm the identity of the telephone 6 by requesting the customer to, for example, enter a displayed personal identification number (PIN). Thus the sales point 1 having captured the identity of the mobile unit 6 present or having been informed of the cellular telephone number or land line telephone number of the consumer, will display a code which when entered confirms the presence of the appropriate instrument thereby confirming and validating the sale to the account database 7.

Turning now to FIG. 5, the sale point 1, which may otherwise be a standard electronic point of sales (EPOS) terminal in the principal mode of operation on completion of entry of sales costs, for example automatically by bar code scanning, or by customer selection having been informed that the call is for a telephone account transaction as indicated at step 500, establishes a call to the authorisation centre, as indicated at step 505, causing the transaction application 2 of FIG. 1 or 4 to commence operation. As now indicated at step 510, the sales point 1 causes transmission of the EPOS identity and the value of the transaction to be effected. The transaction application having reserved a telephone number for effecting a call from the mobile transmits the destination data back to the EPOS terminal which receives destination data as at step 515.

The EPOS terminal may determine whether the transaction is to be confirmed by use of an infrared or low power radio port associated with the cellular telephone presence and if so transmits the received telephone number to the localised instrument at step 525. Alternatively, where the transaction instrument is not in direct communication with the EPOS terminal, the number to be called is displayed at step 530. In both cases at step 535 a timer is commenced giving the instrument or the user time to effect a call to the premium rate number and a message is awaited from the transaction application to confirm or decline the caller request. Thus, at step 540, the system monitors for received data until the timer expires, at step 545, or until such time as the data is received.

If the data is not received before the expiry of the timer at step 545, then the transaction will be declined at step 550 and the call cleared at step 565.

In the alternative when data is received at step 540, the received message is examined to determine whether the call is to accept the transaction or to reject it.

As indicated at step 555, if the transaction is accepted, as indicated at step 560, the call is then cleared charges having been made to the appropriate account either related directly to the billing of the network on which the phone is operable or in respect of an account transaction on the account database 7. In the alternative the transaction may be declined in which case the EPOS terminal does not effect clearance of the transaction and if in a vending machine or Internet situation declines to supply the goods or services requested.

Thus, turning initially to FIG. 6, the transaction application 2 to FIG. 2, on receipt of an authorisation request, at step 600, as transmitted at step 505 of FIG. 5, receives the identity of the sales terminal and the transaction value. The transaction application will now determine which of the groups of premium rate numbers 5 is appropriate for the transaction value and will select one of the telephone nodes within the appropriate group PRa to PRd and will mark that node within its own data as busy at step 615 so that no two calls are received on the same telephone number at the same time.

The selected node telephone number is now transmitted at step 620 to the EPOS 1 for display or transmission to the customer as previously described. A timer is set at step 625 and the selected telephone node is monitored by the application at step 630 for an incoming call at step 635. Assuming that a call is received on the appropriate selected telephone number then an authorisation to proceed with the transaction is transmitted at step 640.

If however, as indicated at step 645, the timer set at step 625 expires prior to receipt of an incoming call, then the transaction is declined and a data message defining refusal of the transaction is transmitted at step 650. Once the data message is transmitted at step 640 or 650, then at step 655 the busy marker is cleared from the selected node so that it now becomes available for further calls in respect of other transactions.

It will be noted that an incoming call may not be received either because the caller does not make an appropriate telephone call or because the intelligent network blocks the call as a result of insufficient credit standing to the identified telephone terminal 6.

Turning now to FIG. 7 in the operation of the system of FIG. 4, crediting of the account database may occur in a similar way to that previously noted in respect of FIG. 6. However, in this case an account database 7 stores a higher value amount against a CLI of, for example, a mobile phone although such transactions need not be so limited. Thus, in this case the customer determines an amount that shall be credited to his or her account and dials a premium rate number in one of the groups 5 thereby causing an appropriate credit to be indicated to the telephony platform 3 and hence through the transaction application 2 to be stored in the account database 7.

When an authorisation request is received at step 700 the functionality is similar to that of FIG. 6 for steps 705 to 735 each equivalent to steps 605 to 635 respectively of FIG. 6.

At step 735 when an incoming call is received then at step 740 the CLI is received from the network and, in the case of a cellular telephone call, a location may also be received for example determined by triangulation in known manner or from use of GPS sensing.

Generally speaking, at step 750, the call can be rejected thereby not causing any charging to be raised through the network 4. In the case of a cellular transaction a check may be made to determine that the location of the calling instrument 6 corresponds to the location of the EPOS terminal as determined from the EPOS terminal identity and if this is not the case then the transaction may be declined at step 765 in the same manner as if the timer expired with no call being received by the appropriate telephone node.

Having received the location and validated it (if appropriate) a check is now made with the database 7 of FIG. 4 to determine whether the account identified by the CLI of the calling instrument has a sufficient credit for the transaction being requested. Thus as indicated at step 760, if sufficient funds are available then an authorisation will be transmitted at step 770. Once again if insufficient credit is allowed against the account indicated by the CLI then a decline message may be transmitted to the sales point 1. Finally, at step 775, a busy marker is cleared from the node so that it is freed up for subsequent use.

Again, it is possible to reverse the authorisation function so that the sales point may capture the identity of the telephone instrument and may cause a call to be transmitted from the telephony platform to the instrument so that on answer of the instrument entry of a simple PIN code either predetermined or displayed at the point of sale may be used to authorise the transaction.

Although the present invention is particularly suited to authorisation of small value transactions at EPOS terminals, it should be noted that higher value transactions can be authorised, for example, by placing substantial funds in escrow in the account held at the database 7. Such a function could be performed by way of a banking transaction or by direct transfer of funds into the account from a credit or debit card.

While transaction authorisation has been described, in particular, by use of a mobile terminal, it will also be appreciated that transactions involving the Internet, for example, could be based on the CLI of a fixed land line telephone.

1. A transaction authorisation system comprising a service platform in communication with a telephone network, and a plurality of sales points each point having respective customer communication means responsive to signals from the service platform to communicate to a customer or a customer terminal associated with the customer information defining a node of the communications network to which calls can be placed, the service platform including means responsive to a request from sales point to select one of a multiplicity of network nodes for transfer and to communicate the identity of the selected network node to the requesting terminal and monitoring means for monitoring the selected network node for a communication, means for capturing the identity of a customer terminal calling the selected network node and means to indicate to the requesting point of sales terminal that a transaction is authorised.

2. A transaction authorisation system as claimed in claim 1 in which a multiplicity of network nodes are reserved to the system, the nodes being divided in to a plurality of groups each comprising a plurality of the multiplicity of nodes, each said group being associated with a particular transaction value, whereby calls to a particular node result in a charge being applied to an account associated with the calling instrument.

3. A transaction authorisation system as claimed in claim 1 in which at least one sales point includes means to transmit a selected telephone network node number directly to a customer instrument whereby automated dialling of the selected network node may occur.

4. A transaction authorisation system as claimed in claim 1 in which at least one sales point is capable of capturing the identity of a customer instrument and of transmitting said identity to the service platform, the service platform being responsive to receipt of said identity to establish a call through the telephone network to the customer instrument.

5. A transaction authorisation system as claimed in claim 4 in which the sales point displays a PIN which is transmitted from the service platform to the point of sale terminal, the service platform requiring a user to enter the PIN in response to the call from the service platform prior to authorising the transaction.

6. A transaction authorisation system as claimed in claim 4 in which the point of sale terminal generates a random PIN in respect of each transaction and transmits the PIN to the service platform, the service platform requiring a user to enter the PIN in response to the call from the service platform prior to authorising the transaction.

7. A method of charging for a transaction comprising the steps of identifying a value for the transaction, selecting from a plurality of telephone numbers a number having a corresponding value associated therewith, displaying the number selected and monitoring a network node corresponding to the number selected for an incoming call, on receipt of an incoming call determining the identity of the calling terminal, charging an amount corresponding to the value to a respective account associated with the calling terminal and authorising the transaction.

8. A method of charging as claimed in claim 7 including determining the sufficiency of credit in a respective account associated with a calling instrument prior to authorising the transaction.

9. A method of charging as claimed in claim 7 in which, the account associated with a calling instrument has an associated credit limit and the method includes the step of determining the sufficiency of available credit prior to authorising the transaction.

10. A method of charging as claimed in claim 7 in which the corresponding value is allocated to the selected network node at the time of allocation.

11. A method of charging for a transaction comprising the steps of identifying a value for the transaction, selecting a network node from a plurality of available network nodes, transmitting the identity of the node for transmission to a user, monitoring the selected network node for a call and identifying the calling terminal and debiting an account associated with the calling terminal prior to authorising the transaction.
